(19) United States
(12) Patent Application Publication
(10) Pub. No.: US 2011/0151268 A1
(43) Pub. Date: Jun. 23, 2011

(54) MATERIAL COMPRISED OF METAL AND LACTIC ACID CONDENSATE AND ELECTRONIC COMPONENT

(75) Inventors: Wolfgang Schmitt, Rodgau (DE); Michael Schaefer, Kuenzell (DE); Ferdinand Bartels, Darmstadt (DE)

(73) Assignee: W.C. HERAEUS GMBH, Hanau (DE)

(21) Appl. No.: 13/060,151

(22) PCT Filed: Aug. 19, 2009
(86) PCT No.: PCT/EP09/05992

§ 371 Date: Feb. 22, 2011

(30) Foreign Application Priority Data
Aug. 22, 2008 (DE) 102008039247.2
Mar. 26, 2009 (DE) 102009014424.2

(51) Int. Cl. C09D 1/00; B32B 15/04; C08K 3/08; B05D 5/12

(52) U.S. Cl. 428/457; 106/1.18; 106/1.19; 428/689; 524/440; 427/125; 427/123

(57) ABSTRACT

A material is provided containing a metal and a lactic acid condensate, wherein the metal is selected from the group of copper, silver, and gold. An electronic component having a surface made of metal, ceramic, or oxide may be coated with the material. A method for the production of metallic surfaces on an electronic component is also provided.

### CROSS-REFERENCE TO RELATED APPLICATIONS

This application is a Section 371 of International Application No. PCT/EP2009/005992, filed Aug. 19, 2009, which was published in the German language on Feb. 25, 2010, under International Publication No. WO 2010/020400 A3 and the disclosure of which is incorporated herein by reference.

### BACKGROUND OF THE INVENTION

The invention relates to a material comprising metal and a lactic acid condensate, as well as to an electronic component having a coating comprising the material, and a method for producing metallic surfaces of an electronic component.

The present invention relates in particular to the production of metallizations on oxidic surfaces, in particular ceramic surfaces, or on metals, in particular on aluminum, copper, silver, gold, or nickel; and priming coats for the production of metal priming coats, as well as their use for the mounting of bodies.

Known methods for the generation of priming coats are the known thin-film methods, as for example sputtering or vacuum deposition, and the known thick-film methods, as for example screen printing and galvanic deposition. The galvanic and thin-film methods are fundamentally expensive due to the apparatus and procedure. The thick-film technology is indeed simple, but requires high temperatures and is therefore ruled out as a metallization method for temperature-sensitive substrates, e.g. plastics.

The textbook on chemistry by J. J. Berzelius, Vol. 6, pp. 137/138, Dresden and Leipzig, 3rd edition (1837) describes lactic acid salts of silver and copper.

Copper, silver, and gold are hard solders.

### BRIEF SUMMARY OF THE INVENTION

An object of the present invention is to provide metallizations comprising copper, silver, and gold acting gently on surfaces of electrical components, which do not withstand a temperature load of 250° C., in particular 300° C., or in mounting bodies under gentle conditions by copper, silver, or gold.

To achieve the object a primer is provided, which breaks down to a metal at 150° C. to 300° C., in particular 200° C. to 250° C.

The achievement of the object is realized by a material comprising metal and a lactic acid condensate, wherein the metal is selected from the group of copper, silver, and gold. The object is further realized by a method for the production of metallic surfaces on an electronic component, characterized in that the metal as a metallic powder or powder of a compound of the metal with water and lactic acid is converted above the boiling point of water into a viscous or paste-like product, this viscous or paste-like product is applied on the component surface, and the applied layer is converted into a metal layer.

### DETAILED DESCRIPTION OF THE INVENTION

According to the invention, a priming coat agent based on a metal or a metal compound of copper, silver, or gold and lactic acid derivatives is deposited as a primer for the generation of a metallization, and after the application between 150° C. and 300° C. is transformed into the desired metallization. According to the invention, in this way especially adhesive metallizations with layer thicknesses between 10 and 50 μm, particularly 20 to 30 μm, can be realized in an especially easy way. Even heat-resistant plastics, for example fluoropolymers or polyimides, can be provided with the metallizations according to the invention. Furthermore, there are a plurality of applications in which a deposition of a metal on another metal cannot be realized with the thick-film technology, but can be realized with the present invention, as for example the application of silver on aluminum.

The material forming the basis of the priming coat agent is in particular a solution or a compound of copper, silver, or gold. Here, above all, materials based on copper or silver are water-soluble. The lactic acid derivatives are condensates. Especially suitable is a ratio of four lactic acid derivative units per metal atom.

For the production of a coating agent, in particular a priming coat agent, according to the invention a metal or metal compound is boiled with an aqueous lactic acid solution above 100° C. until a viscous or paste-like mass is produced. This is an especially simple production of a metal compound, in particular a silver compound, which is suitable for the metallization of materials, especially glass, ceramic, and aluminum.

The coating agent according to the invention is suitable as an adhesive between pre-sintered metal, in particular silver, surfaces for the generation of heat or electrically conductive contacts or for the generation of conductor strips.

A cooling body is easily applied by sintering on a ceramic of a DCB coated according to the invention.

The coating of silicon wafers is performed without a problem. Especially for photovoltaic materials, a coating of aluminum surfaces on silicon wafers according to the invention simplifies a contacting with copper or silver small bands.

A coating of glass solders according to the invention simplifies the connection of glass and metal.

The metallic coating of glass fibers is simplified. In this way, a simple production of conductive cellulose, threads, and textiles is made possible.

Furthermore, the material according to the invention is suitable as a hardener, especially for acrylate and cyan esters. The compounds of Cu, Ag, and Au according to the invention break down only above 100° C. and therefore can be mixed with the polymer base material in a storage-stable way. The hardening effect is initiated by an increase in temperature only when needed.

The simple production of metal surfaces made possible according to the invention by the breakdown of lactic acid derivatives below 350° C., in particular below 300° C., opens up a new joining technique. Metals on the basis of copper, silver, or gold, which were previously used as hard solders above 400° C., can be applied according to the invention under soft-solder conditions. Thus, instead of typical soft solders, metals that were previously foreign to soft-solder processing, in particular tin alloys with a high percentage of copper, silver, or gold, can also be applied under the conditions of soft solder.

In the following, the invention will be made clear with reference to examples.

### EXAMPLE 1

Upon boiling of copper powder or copper oxide powder in an aqueous lactic acid solution, a clear green solution is produced, which is heated at 180° C. until it is no longer water-soluble. This water-insoluble, copper-containing mass is printed as a priming coat on ceramic surfaces of electrical components for the generation of metallizations. The printing is dried and annealed between 200° C. and 250° C., especially under protective gas, until a copper metallization is present.

### EXAMPLE 2

Upon boiling of silver powder or silver oxide powder in an aqueous lactic acid solution, the mixture is heated to 200° C. as a water-insoluble, yellow, viscous solution or flowable paste-like mass. The silver content equals 20 to 25 wt. %. An excess of silver components remains undissolved.

This silver coating agent is applied on plates made of PTFE, polyimide, glass, a ceramic substrate made of aluminum oxide, and substrates having a surface made of Al, Cu, Ag, Si, and Ni, and after the application at 280° C. breaks down into a silver metallization. The metallizations adhere very tightly on the respective base. The silver metallizations are solderable with soft solder, even if the base was previously not. On the silver metallizations, additional metal pastes were applied, with which mechanically tight and thermally and electrically conductive compounds are generated between two previously loose components.

### EXAMPLE 3

Silver lactide is added as a hardener for the polymerization of acrylates, epoxides, lactides, or cyanates to resins to be hardened. These mixtures are stable for storage. The hardening takes place at temperatures above 120° C., especially above 180° C.

### EXAMPLE 4

A gold coating agent is generated by boiling of a gold compound in an aqueous lactic acid solution, wherein by heating the mixture to 300° C. a solution is first generated, which transforms into a water-insoluble, flowable mass. The gold content equals 20 to 30 wt. % at a maximum up to a stoichiometric ratio 1:4 of gold to lactic acid units.

This water-insoluble gold coating agent is applied on plates made of PTFE, polyimide, glass, a ceramic substrate made of aluminum oxide, and substrates having a surface made of Al, Cu, Ag, and Ni, and after the deposition between 200° C. and 300° C. breaks down into a gold metallization. The metallizations adhere very tightly onto the respective base. On the gold metallizations additional metal pastes are applied, with which mechanically tight and thermally and electrically conductive compounds are generated between two previously loose components.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1.-12. (canceled)

13. A material comprising metal and a lactic acid condensate, wherein the metal is selected from the group of copper, silver, and gold.

14. The material according to claim 13, wherein the material is selected from a solution and a compound.

15. The material according to claim 13, wherein the material is selected from a lactide, a dilactide and a polylactide.

16. The material according to claim 13, wherein the material has 4 derivatized lactic acid units per metal atom.

17. An electronic component having a surface made of metal, ceramic, or oxide, wherein the surface is coated with a material according to claim 13.

18. The electronic component according to claim 17, wherein the electronic component is one that would be damaged at temperatures above 300° C.

19. A method for production of metallic surfaces on an electronic component, the method comprising providing a metallic material as a metallic powder or powder of a compound of a metal with water and lactic acid, converting the metallic material above the boiling point of water into a viscous or paste-like product, applying the viscous or paste-like product on a surface of the component, and converting the applied product into a metal layer on the component surface.

20. The method according to claim 19, wherein the metal is selected from the group of silver, copper, and gold.

21. The method according to claim 19, wherein the metal is applied onto the component surface at a temperature between 150° C. and 300° C.

22. A method for forming a priming coat for metal contacts, the method comprising applying the material of claim 13 to a surface to be primed.

23. A method for mounting a body on a substrate, the method comprising applying the material according to claim 13 to a surface of the substrate as a connection for the body.

24. A method for hardening a polymer, the method comprising mixing the material according to claim 13 into the polymer as a hardener.
